(19) United States
(12) Patent Application Publication
(10) Pub. No.: US 2003/0090797 A1
(43) Pub. Date: May 15, 2003

(54) License plate

(76) Inventor: Michael Mueller, Gifhorn (DE)

Correspondence Address: KENYON & KENYON, ONE BROADWAY, NEW YORK, NY, 10004, US

(21) Appl. No.: 10/130,073

(22) PCT Filed: Aug. 4, 2001
(86) PCT No.: PCT/EP01/09046

(30) Foreign Application Priority Data
Sep. 12, 2000 (DE) 100 4 882.8

(51) Int. Cl. G02B 5/12

(52) U.S. Cl. 359/515

(57) ABSTRACT

The present invention relates to a license plate, which has an upper side that is facing an observer in a mounted state, a lower side that faces away from an observer in a mounted state, and a luminous sheet (18), the luminous sheet (18) being provided with reflecting means (20), either directly, or using at least one further layer.

The present invention relates to a license plate, which has an upper side that is facing an observer in a mounted state, a lower side that faces away from an observer in a mounted state, and a luminous sheet.

Conventional license plates for motor vehicles have a reflective upper surface. In this manner, such license plates are also readable in the dark, that is, when the license plate is illuminated by a portion of the vehicle lighting, or by other light sources.

It has already been proposed that this indirect lighting be replaced by having the license number light up itself. This allows the license number to be recognized very easily in the dark. In addition, a self-illuminating design is aesthetically preferable.

However, a self-illuminating license plate also has problems. Thus, the legislature stipulates that a license number have a certain reflectivity, which especially plays an important roll with regard to recording regulatory offences in the case of speed traps. The use of a self-illuminating license plate of the related art does not satisfy these regulations.

Therefore, the object of the present invention is to provide a license plate, which has a luminous sheet and eliminates the above-mentioned disadvantages.

This object is achieved by the features of the independent claim. Advantageous specific embodiments are given in the dependent claims.

The present invention builds on the license plate of the species by providing the luminous sheet with reflecting means. In this manner, the advantages of a self-illuminating license plate are advantageously combined with the legal requirements.

The luminous sheet is preferably an electroluminescent sheet. Therefore, the sheet may be illuminated in a desired manner by applying a suitable voltage.

The reflecting means are advantageously designed as a part of the luminous sheet. Thus, the luminous sheet may have reflective properties itself, which particularly simplifies the design of the license plate.

However, it may be advantageous for the reflecting means to be in the form of a sheet that is positioned over the luminous sheet. This allows an electroluminescent sheet to be used as a luminous sheet without subjecting it to further processing steps. Rather, it is only necessary to position a reflecting sheet above the electroluminescent sheet.

It is preferable for a window to be positioned over the luminous sheet. This protects the sensitive components of the license plate from outside influences. In addition, this effects the visual appearance of the license number in a positive manner.

In this case, it may be useful for the reflecting means to be designed as part of the window. Therefore, it is possible to neither provide the electroluminescent sheet with reflecting means itself, nor position an additional, reflecting sheet over the electroluminescent sheet.

It is advantageous for the window to be made of polymethyl methacrylate (PMMA). This is a highly transparent material, which nevertheless has particularly good strength characteristics.

It is particularly preferable for the reflectivity of the reflecting means to be set to a desired value, using a pattern. Such patterns do not only influence the reflectivity for the purpose of exactly fulfilling the regulations, but also have decorative characteristics for the license plate.

It is advantageous for a license-number layer made of polymethyl methacrylate (PMMA) to be provided as the topmost layer. Such a PMMA layer used as a license-number layer may be attached in a particularly secure manner to the window, which is preferably made of PMMA as well. It is possible to hot-stamp the symbols of the license number on the uppermost layer.

It is particularly advantageous for the uppermost layer to have regions for attaching additional designations. For example, these regions may be designed to allow registration tags and technical inspection stickers to be attached in a particularly effective manner. In the case in which, for example, registration tags are to be attached in so-called “cup form”, the license plate according to the present invention may be prepared so that recesses are provided for these cups.

It is particularly preferable for a molded frame to be provided, which may be attached to a vehicle and holds the other components of the license plate. Therefore, the license-plate components that include the electroluminescing sheet do not have to be directly attached to the vehicle, but may simply be held by a protective, molded frame.

It is preferable for the further components of the license plate to only be removable from the molded frame by destroying the molded frame. This increases the security of the license plate against theft, in particular when new molded frames are only issued by the motor-vehicle registration office.

Similar advantages with regard to theft security are realized, when the other components of the license plate are only removable from the molded frame with the aid of special tools.

In this context, it can be particularly advantageous, when the molded frame has designations. Therefore, it would no longer be necessary, for example, to attach a registration tag to the. license plate, but rather, such a registration marking could be positioned on the molded frame, which is already issued new by the motor vehicle registration office for each initial registration.

It is advantageous, when the molded frame is suitable for supporting a conventional license plate. Therefore, the owner of a motor vehicle may even take advantage of a molded frame marked by additional designations, if he or she prefers a conventional license plate for reasons of cost.

A ballast unit is preferably provided, which supplies voltage to the luminous sheet. For example, this control unit is able to supply an electroluminescent sheet with a voltage of approximately 100 V, which is transformed from the usual battery voltage of 12 V. The control unit is connected to the molded frame in such a manner, that the control unit may be removed when the frame is replaced. The control unit is securely connected to the frame during normal vehicle operation.

The present invention is based on the surprising finding, that the advantages of a self-illuminating license plate may easily be combined with the requirements for a certain reflectivity.

The present invention is exemplarily explained below, with reference to the accompanying drawings, using a preferred, specific embodiment.

The figure shows:

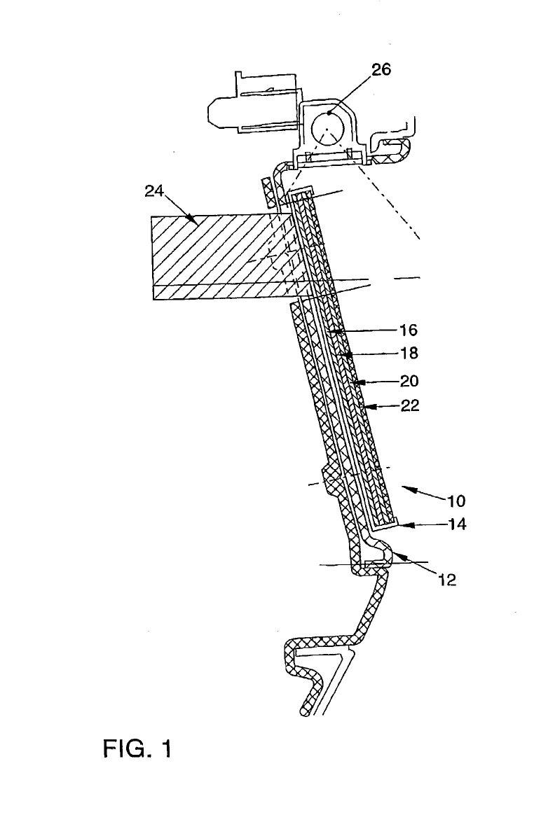

FIG. 1 a section of a motor vehicle having a license plate of the present invention attached to it.

FIG. 1 shows a sectional view of a license plate 10 according to the present invention, which is attached to a motor vehicle. License plate 10 is supported by a license-plate support 12, which is simultaneously used as a bumper. The license plate is held by a molded frame 14. A sequence of layers preferably made of a black, copolymer base plate 16 is situated inside molded frame 14. An electroluminescent sheet 18 is positioned over base plate 16. This may be designed to be reflective. A window 20 made of polymethyl methacrylate (PMMA) is positioned over electroluminescent sheet 18. This window may be designed as a reflector, as well. The actual license number 22 made of PMMA is positioned over the window, as the uppermost layer, the symbols of the license number 22 being hot-stamped. The voltage necessary for lighting up electroluminescent sheet 18 is supplied by a control unit 24.

If one replaces license plate 10 with a conventional license plate that can preferably be supported by molded frame 14 as well, then it is possible to retain a conventional license-plate illumination system 26. This is used in an advantageous manner, not only for illuminating the license plate, but also for pre-illuminating the rear field of the vehicle. For this purpose, four lamps, which illuminate both the license plate and the rear farfield, may be mounted above the license plate as a conventional license-plate illumination system 26.

The features of the present invention discussed in the above description, in the drawing, and in the claims may be essential, both individually and in arbitrary combination, for implementing the present invention.

What is claimed is:

1. A license plate having an upper side that is facing an observer in a mounted state, a lower side that faces away from an observer in a mounted state, and a luminous sheet (18),
wherein the luminous sheet (18) is provided with reflective means, either directly, or using at least one further layer.

2. The license plate as recited in claim 1,
wherein the luminous sheet (18) is an electroluminescent sheet.

3. The license plate as recited in claim 1 or 2,
wherein the reflecting means are designed as a part of the luminous sheet (18).

4. The license plate as recited in one of the preceding claims,
wherein the reflecting means are in the form of a sheet that is positioned over the luminous sheet (18).

5. The license plate as recited in one of the preceding claims,
wherein a window (20) is positioned over the luminous sheet (18).

6. The license plate as recited in one of the preceding claims,
wherein the reflecting means are designed as a part of the window (20).

7. The license plate as recited in one of the preceding claims,
wherein the window (20) is made of polymethyl methacrylate (PMMA).

8. The license plate as recited in one of the preceding claims,
wherein the reflectivity of the reflecting means is set to a desired value, using a pattern.

9. The license plate as recited in one of the preceding claims,
wherein a license-number layer (22) made of polymethyl methacrylate (PMMA) is provided as the uppermost layer.

10. The license plate as recited in one of the preceding claims,
wherein the uppermost layer (22) has regions for attaching additional designations.

11. The license plate as recited in one of the preceding claims,
wherein a molded frame (14) is provided, which may be attached to a vehicle and holds the further components (16, 18, 20, 22) of the license plate (10).

12. The license plate as recited in one of the preceding claims,
wherein the further components (16, 18, 20, 22) of the license plate (10) are only removable from the molded frame (14) by destroying the molded frame.

13. The license plate as recited in one of the preceding claims,
wherein the further components (16, 18, 20, 22) of the license plate (10) are only removable from the molded frame (14) with the aid of a special tool.

14. The license plate as recited in one of the preceding claims,
wherein the molded frame (14) has markings.

15. The license plate as recited in one of the preceding claims,
wherein the molded frame (14) is suitable for holding a conventional license plate.

16. The license plate as recited in one of the preceding claims,
wherein a ballast (24) unit is provided, which supplies voltage to the luminous sheet (18).
